(19) United States
(12) Patent Application Publication
(10) Pub. No.: US 2013/0208303 A1
(43) Pub. Date: Aug. 15, 2013

(54) APPLICATION SUPPLYING APPARATUS AND RELAY APPARATUS ON CLOUD

(71) Applicants: Yuki UCHIDA, Lincoln Park, NJ (US); Shun TANAKA, West New York, NJ (US)

(72) Inventors: Yuki UCHIDA, Lincoln Park, NJ (US); Shun TANAKA, West New York, NJ (US)

(73) Assignee: RICOH COMPANY, LTD., Tokyo (JP)

(21) Appl. No.: 13/370,481

(22) Filed: Feb. 10, 2012

(51) Int. Cl. G06F 3/12; G06F 15/16; H04N 1/04; G06F 3/01

(52) U.S. Cl. 358/1.15; 715/740; 358/474

(57) ABSTRACT

An application supplying apparatus, in order to enable a user at a user terminal to access the functionalities of any of plural heterogeneous devices of different vendors, supplies an application via a network to the user terminal. The application supplied to the user terminal includes a common user interface part that provides a user interface through which the user can select a device from amongst the plural heterogeneous devices, and the common user interface part then configures the user interface for access to the functionalities of the selected device.

### TECHNICAL FIELD

This disclosure relates to tools (systems, apparatuses, methodologies, computer program products, etc.) for allowing a user at a user terminal to access via a network the functionalities of plural heterogeneous devices provided by different vendors.

### BACKGROUND

In the current information age, various information technology (IT) tools are extensively used by enterprises and other organizations, in order to provide convenient processing and storage of various documents and data. For example, multi-function devices (MFDs) allow users to perform numerous processing functions with respect to documents and data, such as a scan operation to scan a hardcopy document in order to generate an electronic image of the document, an optical character recognition operation to extract text from the electronic image, a print operation to print out a hardcopy version of an electronic document, etc.

While some functions can be natively provided on the MFD, other functions may be obtained from, or are facilitated by, a server which may provide various support services and functionalities for the operation of the MFD. For example, when the MFD performs a scan operation, the scan image data from the MFD may be transmitted to a server and stored in a document store or other storage device managed by the server (often referred to as “scan-to-store”). As another example, an MFD may allow a user at the MFD to select a document or file stored remotely server-side and request that the selected document or file be printed.

Currently, many enterprises and other organizations do not rely on a single, unified document input/output platform and instead employ heterogeneous MFDs that are provided by different vendors, along with a large number of heterogeneous server devices provided by different vendors for the different multi-function devices.

FIG. 1 illustrates such a conventional system 100 wherein an MFD A 18 provided by Vendor A includes a Server A client 18-1, and MFD A 18 is connected via a network connection 11-1 to Server A that is also provided by Vendor A. The system 100 of FIG. 1 also includes an MFD B 19 provided by Vendor B that includes a Server B client 19-1, and MFD B 19 is connected via a network connection 11-2 to Server B that is also provided by Vendor B.

However, each vendor typically has an established set of software, communication protocols and data formats. That is, MFD A and server A communicate with each other using a first communication format established by vendor A, while MFD B and server B communicate with each other using a second communication format established by vendor B.

Accordingly, a user of MFD A is able to access the functionalities offered by server A (such as being able to access documents, data and software stored on server A), but is not able to access the functionalities offered by server B, since MFD A and server B use different communication formats and are unable to fully communicate with each other. Similarly, a user of MFD B can access the functionalities offered by server B (such as accessing documents, data, software on server B), but is not able to access functionalities offered by server A, since MFD B and server A use different communication formats and are unable to properly communicate with each other.

Each MFD (e.g., MFD A and MFD B in FIG. 1) conventionally includes a user interface to allow the user to access the functionalities of that MFD. However, the user interface of MFD A typically has a different presentation format, layout and style, etc., as compared to the user interface of MFD B. Thus, users of both MFD A and MFD B are forced to learn, and adapt to, the different user interfaces of the different MFDs.

There exists a need for an improved system for accessing the functionalities of plural heterogeneous multi-function devices and plural heterogeneous server devices provided by different vendors.

### SUMMARY

In an aspect of this disclosure, there is provided a tool (for example, an application supplying apparatus, application software, etc.) for allowing a user at a user terminal to access from the user terminal via a network the functionalities of plural heterogeneous devices provided by different vendors.

In an exemplary embodiment, an application supplying apparatus is provided to supply an application (or application software), on demand or otherwise, to the user terminal, and the application includes a common user interface part that provides the user terminal with a user interface through which the user can select a device from amongst the plural heterogeneous devices to access the functionalities of the selected device. After the device is selected, the user interface is configured for user selection of functionalities from amongst the functionalities of the selected device.

In another aspect, the common user interface part of the application supplied by the application supplying apparatus to the user terminal enables the user at the user terminal to operate, via the network, each and all of the plural heterogeneous devices, as if the user were actually operating each specific device via the native user interface of the device. Thus, such common user interface part functions as a unified interface that can replace the need for the user to operate the different native user interfaces of plural respective heterogeneous devices.

It should be appreciated that various embodiments of the application supplying apparatus are possible (and only a few are discussed herein). For example, the application supplying apparatus may supply the application in a manner known commonly as Application Service Provider (ASP) in which the bulk of the processing is performed on the application supplying apparatus end, thus allowing the processing and storage resources on the user terminal to be largely used for other purposes. In such embodiment, the application may provide, for example, a thin client constituted by the common user interface part, and the user instruction and any image data are forwarded to the application supplying apparatus for processing and conversion. For example, an application processing unit of the application supplying apparatus performs the instruction conversion and data conversion, and the application supplying apparatus transmits the converted instruction (in the format native to the selected device) to the selected device.

In another exemplary embodiment, the application supplying apparatus may supply the application in manner known commonly as Software as a Service (SaaS), and the application executing on the user terminal may include one or more other parts (in addition to the common user interface part). When the common user interface part receives user selection of a specific device (from amongst the plural heterogeneous devices) and a user instruction to access functionalities of the selected device, an application processing part of the application executing on the user terminal can convert the user instruction received through the common user interface part into a format native to the selected device, and the application executing on the user terminal causes the terminal to transmit the converted instruction to the selected device in the format native to the selected device.

The functionalities that can be accessed from the user terminal through the application supplied by the application supplying apparatus are not specifically limited. For example, the user terminal may access via the network one or more functionalities of a multi-function device that include document scan operations (for example, scan-to-email, scan-to-store, capture- and distribute, etc.), document print operations (for example, secure print, etc.), facsimile operations (for example, network, fax, etc.), etc.

### BRIEF DESCRIPTION OF THE DRAWINGS

The aforementioned and other aspects, features and advantages can be more readily understood from the following detailed description with reference to the accompanying drawings wherein:

FIG. 1 shows a block diagram of a conventional system including plural multi-function devices and plural server devices;

FIG. 2 shows a block diagram of a system including plural heterogeneous devices, a terminal and an application supplying apparatus, according to an exemplary embodiment;

FIG. 3 illustrates an example of a user interface screen provided by common user interface 20b depicted in FIG. 2, that allows a user to select a print device;

FIG. 4A illustrates an example of a user interface screen displayed on MFD A depicted in FIG. 2;

FIG. 4B illustrates an example of a user interface screen displayed on MFD B depicted in FIG. 2;

FIG. 5 illustrates an example of a user interface screen provided by common user interface 20b depicted in FIG. 2, according to an exemplary embodiment;

FIG. 6 illustrates an example of a file browse page provided by common user interface 20b depicted in FIG. 2, according to an exemplary embodiment;

FIG. 7 shows a flowchart of a method performed by an application supplying apparatus or application supplying apparatus 20 depicted in FIG. 2, according to an exemplary embodiment;

FIG. 8 shows a block diagram of an exemplary configuration of a computer that can be used to implement application supplying apparatus 20 illustrated in FIG. 1;

FIG. 9 shows a block diagram of an exemplary configuration of a multi-function device, such as MFD A and/or MFD B illustrated in FIG. 2;

FIG. 10 shows a more detailed flowchart of a more detailed method performed by application supplying apparatus 20 depicted in FIG. 2, according to an exemplary embodiment;

FIG. 11 illustrates a schematic diagram demonstrating a data flow in a system, such as system 200 illustrated in FIG. 2, according to an exemplary embodiment;

FIGS. 12A and 12B shows a more detailed flowchart of a more detailed method performed by application supplying apparatus 20 depicted in FIG. 2, according to an exemplary embodiment;

FIG. 13 illustrates a schematic diagram demonstrating a data flow in a system, such as system 200 illustrated in FIG. 2, according to an exemplary embodiment;

FIGS. 14A and 14B shows a more detailed flowchart of a more detailed method performed by application supplying apparatus 20 depicted in FIG. 2, according to an exemplary embodiment;

FIG. 15 illustrates a schematic diagram demonstrating a data flow in a system, such as system 200 illustrated in FIG. 2, according to an exemplary embodiment;

FIG. 16 shows a block diagram of a system wherein an application supplying apparatus additionally includes an authentication part, according to another exemplary embodiment;

FIGS. 17A and 17B illustrate examples of user interface screens displayed on the application supplying apparatus 20-1 illustrated in FIG. 16, that allow a user to enter a user name and password for authentication; and

FIG. 18 shows a block diagram of a system including plural heterogeneous devices, a terminal and an application supplying apparatus providing an application as a service (SaaS), according to another exemplary embodiment.

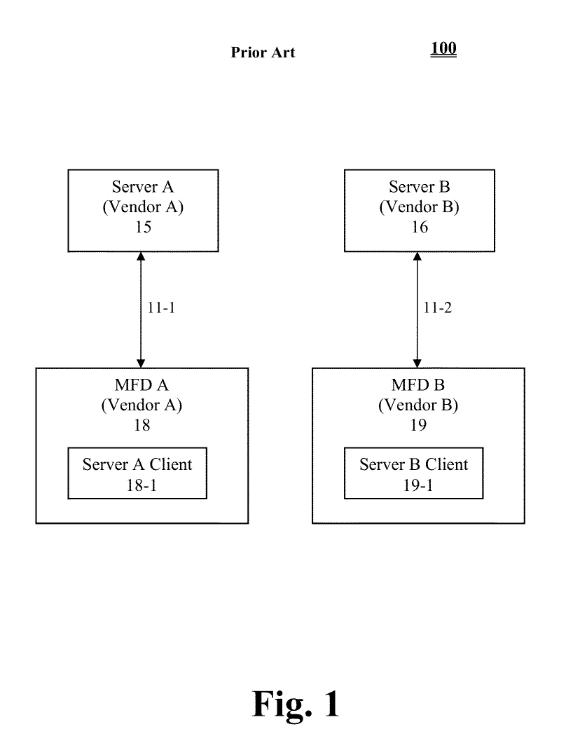

### DETAILED DESCRIPTION

In describing preferred embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner. In addition, a detailed description of known functions and configurations will be omitted when it may obscure the subject matter of the present invention.

On the other hand, it should be appreciated that the term “heterogeneous devices” as used herein refers to plural devices that do not share a common instruction format, nor optionally a common data format.

Referring now to the drawings, wherein like reference numerals designate identical or corresponding parts throughout the several views, there is described tools (systems, apparatuses, methodologies, computer program products, etc.) for accessing the functionalities of plural heterogeneous devices.

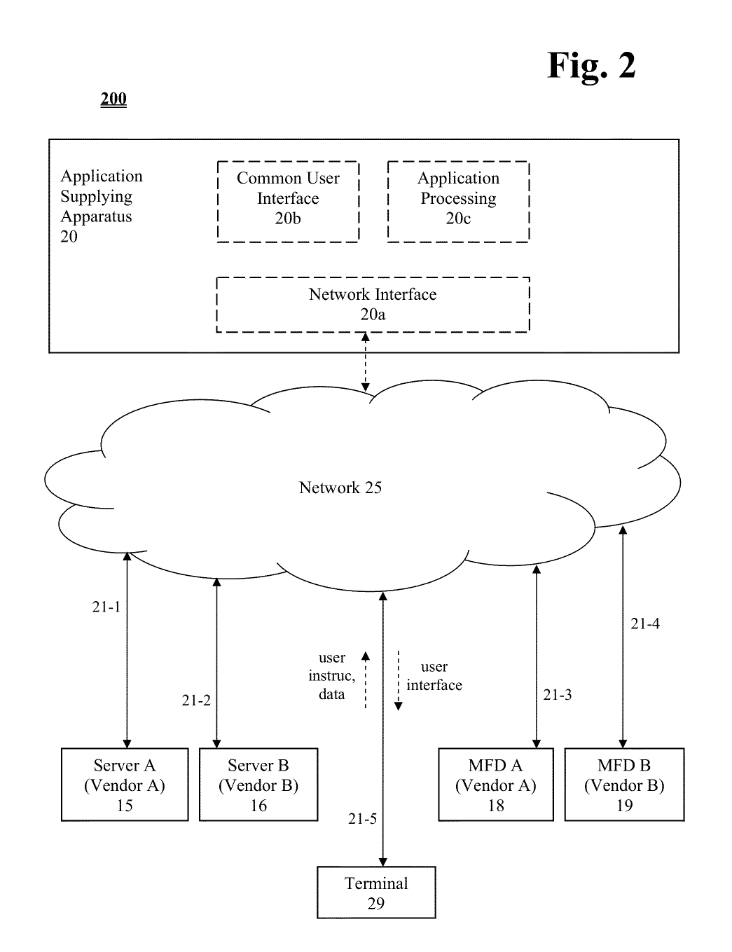

For example, FIG. 2 shows schematically a system 200 for accessing the functionalities of plural heterogeneous devices. In the example illustrated in FIG. 2, the system 200 includes plural heterogeneous devices Server A 15, Server B 16, MFD (multi-function device) A 18, MFD B 19. According to this non-limiting exemplary embodiment, Server A may be a server device manufactured and/or provided by a Vendor A, whereas server B may be a server device manufactured and/or provided by a Vendor B. Thus, Server A and Server B represent plural heterogeneous server devices that may include different software and provide different services. The system 200 also includes plural MFDs, MFD A 18 and MFD B 19. According to this non-limiting exemplary embodiment, MFD A may be a multi-function device manufactured and/or provided by a Vendor A (the same vendor that provides server A), whereas MFD B may be a multi-function device manufactured and/or provided by a Vendor B (the same vendor that provides server B). Thus, MFD A and MFD B represent plural heterogeneous multi-function devices that may include different software and provide different services. Although the plural heterogeneous devices in the example illustrated in FIG. 2 are multi-function devices and server devices, it should be appreciated that one or more of the heterogeneous devices may be another device (other than MFD or server) that provides functionalities a user may wish to access from a terminal.

The server A 15, server B 16, MFD A 18 and MFD B are connected by connections 21-1 through 21-4, respectively, to (private or public) cloud network 25. The connections 21-1 through 21-4 may include wired or wireless connections to networks such as the internet, and/or may be wired or wireless direct communication links, as will be described in more detail hereinafter.

The system 200 also includes an application supplying apparatus 20. The application supplying apparatus 20 includes a network interface unit 20a, a common user interface part 20b, an application processing unit 20c. The network interface unit 20a allows the application supplying apparatus 20 to communicate through the cloud network, such as with server A 15, server B 16, MFD A 18, MFD B 19 and terminal 29.

The application processing unit 20c of the application supplying apparatus 20 is configured to control the network interface unit 20a to communicate with any particular device amongst the plural heterogeneous devices in a communication format native to the particular device. For example, if Server A is manufactured and/or provided by Vendor A, then the application processing unit 20c controls the network interface unit 20a to communicate with Server A in a communication format established by Vendor A. If Server B is manufactured and/or provided by Vendor B, then the application processing unit 20c controls the network interface unit 20a to communicate with Server B in a communication format established by Vendor B. Likewise, if MFD A is manufactured and/or provided by Vendor A, then the application processing unit 20c controls the network interface unit 20a to communicate with MFD A in a communication format established by Vendor A. Likewise, if MFD B is manufactured and/or provided by Vendor B, then the application processing unit 20c controls the network interface unit 20a to communicate with MFD B in a communication format established by Vendor B.

The application processing unit 20c may determine an appropriate communication format native to the particular device by any of various known approaches. For example, the application processing unit 20c may refer to a database or table, maintained internally or by an outside source, to determine an appropriate communication format native to the device. As another example, the application processing unit 20c may access an Application Program Interface (API) of the particular device, in order to determine an appropriate communication format native to the device.

In the exemplary embodiment shown in FIG. 2, the application supplying apparatus 20 supplies an application (or application software), on demand or otherwise, to the user terminal 29, and the application supplied to the user terminal 29 includes (and may essentially be constituted by) a common user interface part 20b.

The application supplying apparatus may supply the application in a manner known commonly as Application Service Provider (ASP) and in such arrangement, the terminal operates as a thin client (constituted by the common user interface part) of the service, in which user instruction and any image data are forwarded to the application supplying apparatus for processing and conversion, and the bulk of the processing is performed on the application supplying apparatus end, thus allowing the processing and storage resources on the user terminal to be largely used for other purposes.

For example, an application processing unit of the application supplying apparatus performs the instruction conversion and data conversion, and the application supplying apparatus transmits the converted instruction (in the format native to the selected device) via the cloud network 25 to the selected device. Such apparatus is also referenced as a “cloud relay apparatus”.

The common user interface part 20b is configured to provide a user interface on the terminal 29 to receive user selection of a particular device amongst the plural heterogeneous devices connected to the cloud network 25 in the system (e.g., MFD A, MFD B, server A, server B, etc.). After the device is selected, the common user interface part 20b configures the user interface on the user terminal for user selection of functionalities from amongst the functionalities of the selected device.

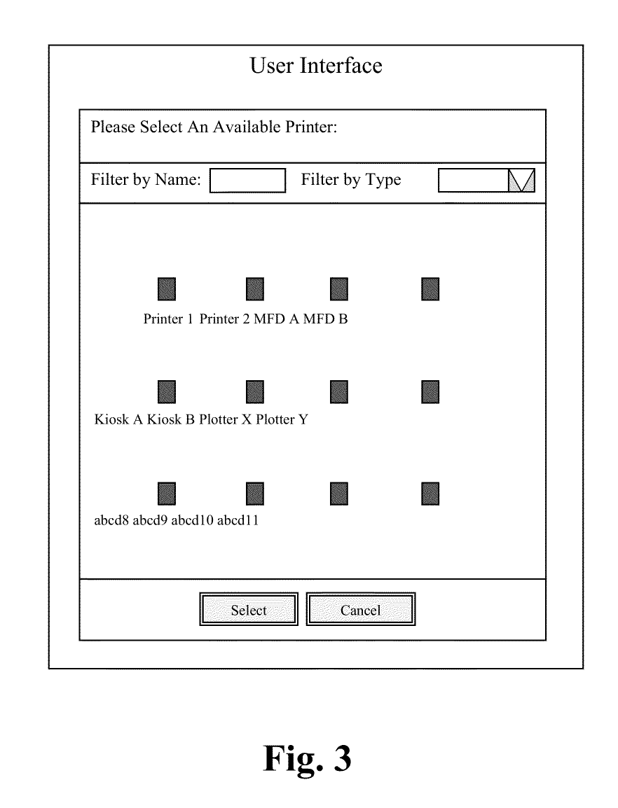

For example, the common user interface part 20b may display a user interface screen on a display unit (LCD, monitor, touchscreen, etc.) of the terminal 29 that allows the user to select a specific device from amongst the heterogeneous devices in the system. FIG. 3 illustrates an example of a user interface screen that can allow a user to select any of plural devices in the system that have print functionalities.

Once the user selects a specific device (via the user interface screen of FIG. 3, for example), the user can be presented with a common user interface on the terminal to access the functionalities of the selected device. Thus, the common user interface may essentially replace the user interface panel or operation control panel natively provided on the selected device (e.g., MFD A, MFD B, etc.), for accessing the functionalities (e.g., copy, scan to email, scan and store, print, fax, etc.) of the selected device from the terminal.

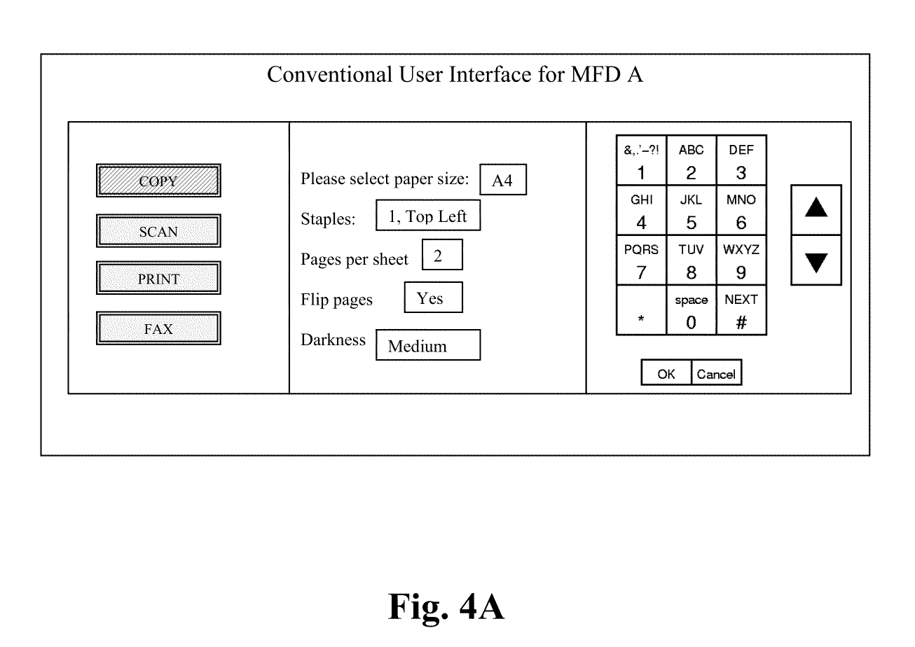

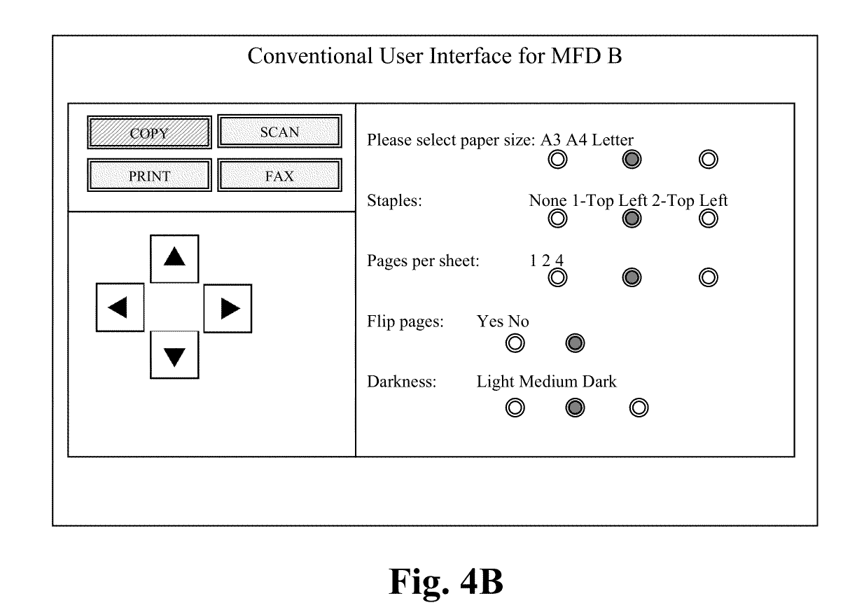

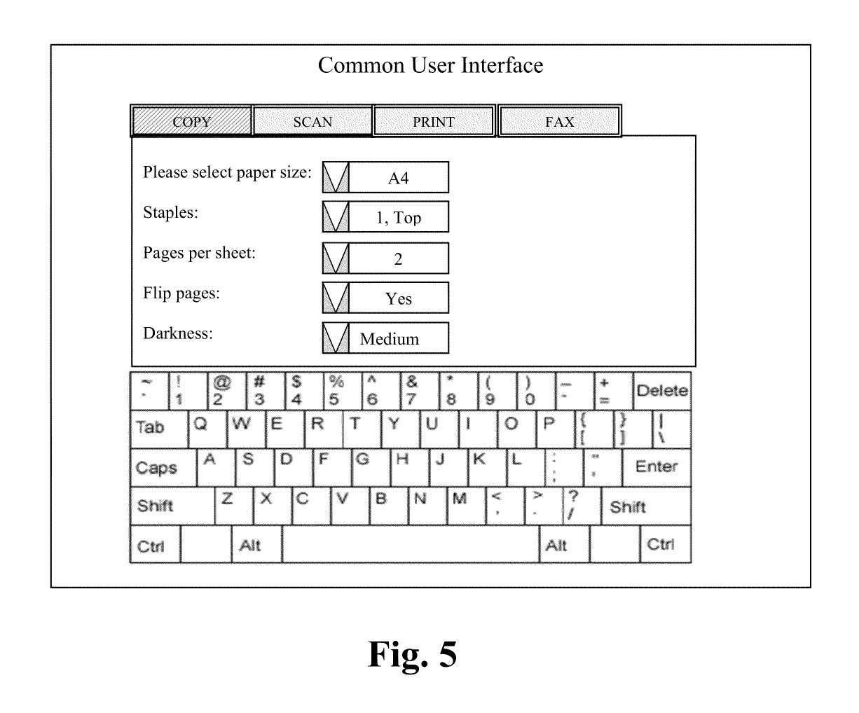

According to an optional aspect of this embodiment, the common user interface provided by the application on the terminal can have the same common, generic format regardless of which device (e.g., MFD A, MFD B, etc.) is selected. An example of a common user interface provided by the common user interface part 20b on the terminal 29 is illustrated in FIG. 5 (compare to the native user interfaces of MFD A and MFD B, illustrated in FIGS. 4A and 4B, respectively).

For example, FIG. 4A illustrates an example of a user interface screen that may be displayed on a display part or operation control panel of the MFD A 18. The user interface illustrated in FIG. 4A allows a user to access the functionalities (e.g., copy, scan, print, fax, etc.) of MFD A. Moreover, the user interface screen of MFD A has a particular style and format, representing the design aesthetic choices and services corresponding to Vendor A that provides and/or manufactures MFD A. As another example, FIG. 4B illustrates an exemplary user interface screen that may be displayed conventionally on a display part or operation control panel of the MFD B 19. As seen in FIG. 4B, the conventional user interface allows a user to access the functionalities (e.g., copy, scan, print, fax, etc.) of MFD B. The user interface screen of MFD B has a particular style and format, representing the design aesthetic choices and services corresponding to Vendor B that provides and/or manufactures MFD B. As seen in FIG. 4B and FIG. 4A, the format of the conventional user interfaces of MFD A and MFD B are different. Thus, users of the conventional user interfaces of MFD A and MFD B are inconvenienced, in that the users must learn and adjust to the differences between the disparate user interfaces.

In contrast, according to an aspect of this embodiment, the common user interface provided on the terminal has the same common, generic format regardless of which of plural devices (e.g., MFD A or MFD B) is selected. That is, if the user selects MFD A or MFD B, the same user interface screen of FIG. 5 may be displayed in order to access the functionalities of the selected device (e.g., MFD A or MFD B). The common user interface of FIG. 5 includes tabs to selects a specific function, such as “copy”, “scan”, “print” and “fax.” The common user interface of FIG. 5 also includes a series of pull-down menus with pre-filled options for the user to select in order to specify various options. The pre-filled options in each of the pull-down menus may be customized based on the device capabilities and services available on the selected device.

After the user selects one of the devices (e.g., MFD A, MFD B, etc.) via the user interface of FIG. 3, and after the user enters a user instruction to access a functionality of the selected device (e.g., entering a scan operation instruction, print operation instruction, etc., via the common user interface of FIG. 5), the application processing unit 20c of the application supplying apparatus 20 is configured to convert the user instruction received through the common user interface part 10b into a format native to the selected device, and to provide the converted user instruction to the application processing unit 20c.

For example, if MFD A is selected and is manufactured and/or provided by Vendor A, the application processing unit 20c converts the user instruction into a communication format native to MFD A and established by Vendor A. The converted instruction is then provided to the application processing unit 20c, which transmits the converted instruction to MFD A in the communication format native to MFD A and established by Vendor A. As another example, if MFD B is selected and is manufactured and/or provided by Vendor B, the application processing unit 20c converts the user instruction into a communication format native to MFD B and established by Vendor B. The converted instruction is then provided to the application processing unit 20c, which transmits the converted instruction to MFD B in the communication format native to MFD B and established by Vendor B. The application processing unit 20c may access an Application Program Interface (API) of each of the MFD A 18 and MFD B 19 in order to convert the user instruction received through the common user interface part 20b into the format native to the selected device.

After the application processing unit 20c transmits the user instruction to the selected multi-function device (e.g., scan operation instruction or print operation instruction), the application processing unit 20c may also receive data from the selected multi-function device. For example, if the user instruction corresponds to a scan operation instruction, the application processing unit 20c may receive scan image data from the selected MFD, which still has to be transmitted to one of the servers A 15 and B 16 for storage. As another example, if the user instruction corresponds to a print operation instruction, the application processing unit 20c may receive a data request for print data from the selected MFD, and the data request may still have to be transmitted to one of the servers A 15 and B 16 in order to obtain the requested data from the appropriate server A or B. Any data received at the application processing unit 20c from the selected multi-function device will be in the format native to the selected multi-function device.

According to an aspect of this exemplary embodiment, the application processing unit determines, based on the user instruction, a specific server device from among the plural server devices to receive the data returned from the selected multi-function device.

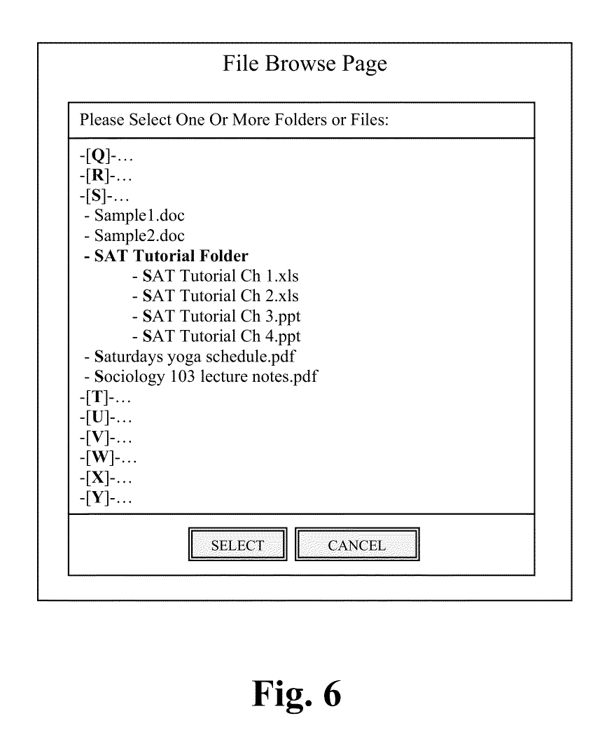

For example, if the user instruction is a scan operation instruction to scan data, the user instruction will typically include a user specification of a storage location on one of the plural server devices for storing the resulting scan image data. For example, the common user interface part may display the user interface screen of FIG. 6 to allow the user to select a storage location and/or storage file for storing the resulting scan image data. The application processing unit 20c will determine which server device, server A and server B, stores the user-designated filed. Thus, after the application processing unit 20c receives scan image data from the selected MFD, which still has to be transmitted to one of the servers A and B 16 for storage, the application processing unit determines a specific server device from among the plural server devices based on the user instruction, and converts (i) the data (which is in the format native to the selected device) received from the selected MFD and (ii) the user instruction, into a format native to the specific server device. Thereafter, the application processing unit 20c transmits the converted scan image data and converted user instruction to the specific server device in the format native to the specific server device, to access the functionalities of the specific server device based on the user instruction (i.e. to store the scan image data at the user designated location).

As another example, if the user instruction is a print operation instruction to print data, the user instruction will typically include a user specification of a file or document stored at a storage location connected to one of the plural server devices for printing. For example, the common user interface part may display the user interface screen of FIG. 6 to allow the user to specify a file or document stored at a storage location connected to one of the plural server devices for printing. The application processing unit 20c will determine which server device, server A and server B, corresponds to the user designated storage location and/or storage file. Thus, after the application processing unit 20c receives a data request for print data from the selected MFD, the application processing unit determines a specific server device from among the plural server devices based on the user instruction, and converts (i) the data request received through the device connector part (which is in the format native to the selected multi-function device) and (ii) the user instruction, into a format native to the specific server device. Thereafter, the application processing unit 20c transmits the converted data request and converted user instruction to the specific server device in the format native to the specific server device, to access the functionalities of the specific server device based on the user instruction (i.e. to request the user-specified file stored at the storage location connected to the particular server device). After the specific server device responds with the requested file, the data can be forward to the selected multi-function device for printing.

Thus, in this exemplary embodiment, there is provided a tool (for example, an apparatus, mobile print application software, etc.) for accessing the functionalities of plural heterogeneous multi-function devices and plural heterogeneous server devices provided by different vendors.

That is, conventionally each vendor typically has an established set of software, communication protocols and data formats, and there is a drawback in that MFD A and server A communicate with each other using a first communication format established by vendor A, while MFD B and server B communicate with each other using a second communication format established by vendor B. Thus, conventionally a user of MFD A may be able to access the functionalities offered by server A (such as being able to access documents, data and software stored on server A), while not being able to access the functionalities offered by server B, since MFD A and server B use different communication formats and are unable to fully communicate with each other.

In contrast, the application supplying apparatus of this exemplary embodiment includes an application processing unit connected to plural heterogeneous server devices provided by different vendors, a device connector part connected to plural heterogeneous multi-function devices provided by different vendors, and a common user interface part to receive user instructions utilizing a common user interface. The application supplying apparatus functions as a ‘black box system’ transparent to the user, and permits the user to operate any MFD (e.g., MFD A or MFD B in FIG. 2) by accessing the functionalities of any server device (e.g., server A or Server B in FIG. 2), and vice versa.

Moreover, while the conventional user interface of MFD A will typically have a different presentation format, layout and style, etc., compared to the user interface of MFD B, the common user interface of this embodiment may be utilized by the user to operate all the MFDs, as if the user were actually operating the user interface screen of each respective MFD. Thus, the common user interface of this disclosure acts as a unified interface that can replace the need for the user to operate the different user interface screens of all the MFDs.

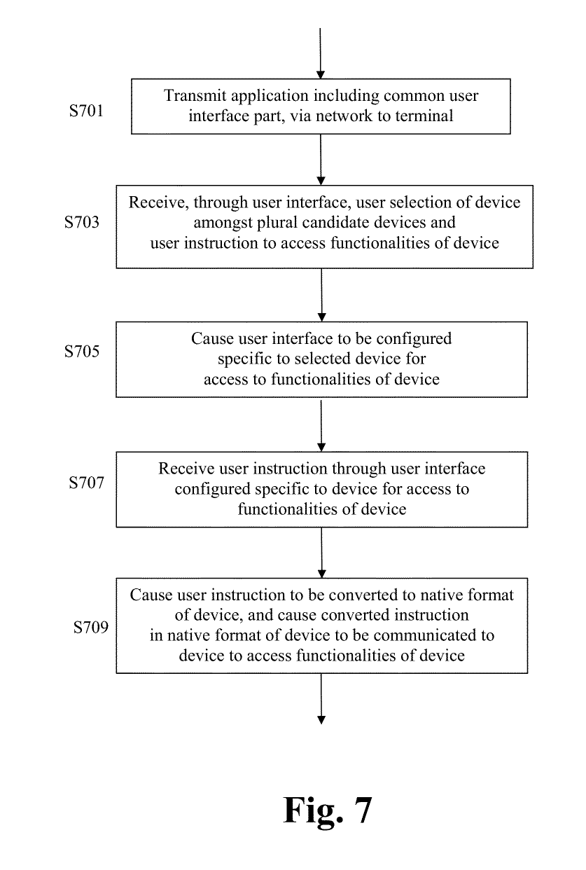

Turning now to FIG. 7, there is shown a flowchart of a method performed by an application supplying apparatus, such as the apparatus 20 illustrated in FIG. 2, according to an exemplary embodiment.

In S701, the application supplying apparatus 20, on demand (e.g., pull by terminal) or otherwise (e.g., push to terminal), provides the application (including common user interface part) via the network 25 to the user terminal. Such application including common user interface part provides a user interface through which is received (S703) user selection of a specific device from amongst the plural heterogeneous devices (e.g., MFD A, MFD B, server A, server B, etc.). After the specific device is selected by the user, common user interface part configures the user interface to be specific to the selected device, for access to functionalities of the selected device (S705). User instruction is received through such user interface configured specific to the selected device, requesting access to specified functionalities of the selected device (S707). causing the user instruction to be converted to a format native to the selected device, and causing the converted instruction in the format native to the selected device to be communicated to the selected device, to access said functionalities of the selected device.

The application supplying apparatus 20 of this disclosure may be realized by a computer or another network-connected device. Various components of the application supplying apparatus 20, such as the common user interface part 20b and the application processing unit 20c, may be manifested as software components corresponding to the aforementioned application.

The apparatus 20 may include a data store that can comprise one or more structural or functional parts that have or support a storage function. For example, the data store can be, or can be a component of, a source of electronic data, such as a document access apparatus, a backend server connected to a document access apparatus, an e-mail server, a file server, a multi-function peripheral device (MFP or MFD), a voice data server, an application server, a computer, a network apparatus, a terminal etc. It should be appreciated that the term “electronic document” or “electronic data”, as used herein, in its broadest sense, can comprise any data that a user may wish to access, retrieve, review, etc.

The network connections 21-1 through 21-5 may be provided via one or more of a secure intranet or extranet local area network, a wide area network (WAN), any type of network that allows secure access, etc., or a combination thereof. Further, other secure communications links (such as a virtual private network, a wireless link, etc.) may be used as well as the network connections. In addition, the network connections 21-1 through 21-5 may use TCP/IP (Transmission Control Protocol/Internet Protocol), but other protocols such as SNMP (Simple Network Management Protocol) and HTTP (Hypertext Transfer Protocol) can also be used. How devices can connect to and communicate over the networks is well-known in the art and is discussed for example, in “How Networks Work”, by Frank J. Derfler, Jr. and Les Freed (Que Corporation 2000) and “How Computers Work”, by Ron White, (Que Corporation 1999), the entire contents of each of which are incorporated herein by reference.

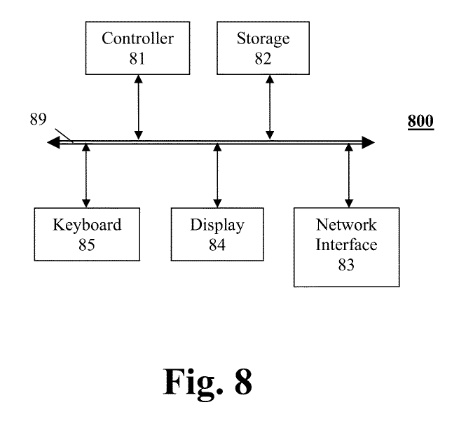

FIG. 8 shows an exemplary constitution of a computer, for example, that can be configured through software to provide the application supplying apparatus 20 illustrated in FIG. 2. As shown in FIG. 8, the computer 800 includes a controller (or central processing unit) 81 that communicates with a number of other components, including memory or storage part 82, network interface 83, display 84 and keyboard 85, by way of a system bus 89.

The computer 800 may be a special-purpose device (such as including one or more application specific integrated circuits or an appropriate network of conventional component circuits) or it may be software-configured on a conventional personal computer or computer workstation with sufficient memory, processing and communication capabilities to operate as a terminal and/or server, as will be appreciated to those skilled in the relevant arts.

In computer 800, the controller 81 executes program code instructions that controls device operations. The controller 81, memory/storage 82, network interface 83, display 84 and keyboard 85 are conventional, and therefore in order to avoid occluding the inventive aspects of this disclosure, such conventional aspects will not be discussed in detail herein.

The computer 800 includes the network interface 83 for communications through a network, such as communications through the networks 21-3 through 21-4 with the plural servers A and B and plural multi-function devices MFDA and MFD B illustrated in FIG. 2. However, it should be appreciated that the subject matter of this disclosure is not limited to such configuration. For example, the apparatus 800 may communicate with client terminals through direct connections and/or through a network to which some components are not connected. As another example, the apparatus 800 need not be provided by a server that services terminals, but rather may communicate with the devices on a peer basis, or in another fashion.

Apparatus 20 is not limited to a computer or server, but can be manifested in any of various devices that can be configured to communicate over a network and/or the Internet.

The apparatus 20, multi-function devices MFD A and MFD B and/or the server devices, server A and server B, may be any network-connected device including but not limited to a personal, notebook or workstation computer, a terminal, a kiosk, a PDA (personal digital assistant), a tablet computing device, a smartphone, a scanner, a printer, a plotter, a facsimile machine, a multi-function device (MFD), a server, a mobile phone or handset, another information terminal, etc. Each device may be configured with software allowing the device to communicate through networks with other devices.

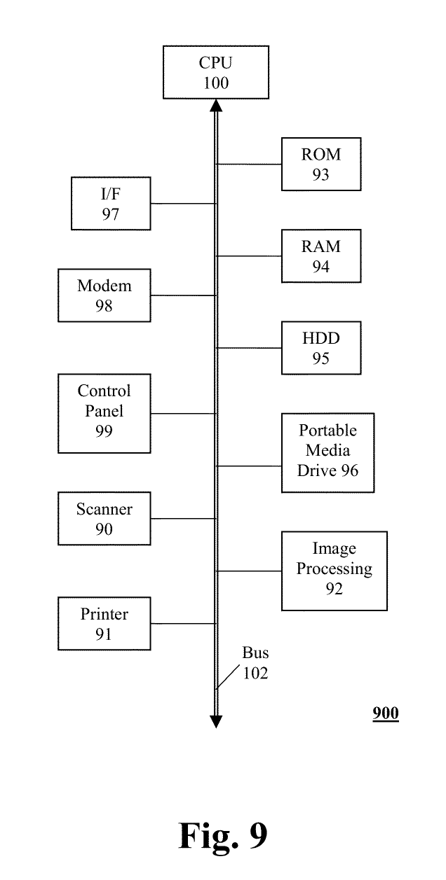

An example of a configuration of a multi-function device (MFD) is shown schematically in FIG. 9. Device 900 includes a central processing unit (CPU) 100, and various elements connected to the CPU 100 by an internal bus 102. The CPU 100 services multiple tasks while monitoring the state of the device 900. The elements connected to the CPU 100 include a scanner unit 90, a printer unit 91, an image processing device 92, a read only memory (for example, ROM, PROM, EPROM, EEPROM, etc.) 93, a random access memory (RAM) 94, a hard disk drive (HDD) 95, portable media (for example, floppy disk, optical disc, magnetic discs, magneto-optical discs, semiconductor memory cards, etc.) drives 96, a communication interface (I/F) 97, a modem unit 98, and an operation panel 99.

Program code instructions for the device 900 can be stored on the read only memory 93, on the HDD 95, or on portable media and read by the portable media drive 96, transferred to the RAM 94 and executed by the CPU 100 to carry out the instructions. These instructions can include the instructions to the device to perform specified ones of its functions and permit the device 900 to interact with other network connected devices.

The operation panel 99 includes a display screen that displays information allowing the user of the device 900 to operate the device 900. The display screen can be any of various conventional displays (such as a liquid crystal display, a plasma display device, a cathode ray tube display, etc.), but is preferably equipped with a touch sensitive display (for example, liquid crystal display), and configured to provide the GUI based on information input by an operator of the device, so as to allow the operator to conveniently take advantage of the services provided by the system. The display screen does not need to be integral with, or embedded in, the operation panel 99, but may simply be coupled to the operation panel by either a wire or a wireless connection. The operation panel 99 may include keys for inputting information or requesting various operations. Alternatively, the operation panel 99 and the display screen may be operated via a keyboard, a mouse, a remote control, touching the display screen, voice recognition, or eye-movement tracking, or a combination thereof. The device 900 is a multifunction device (with scanner, printer and image processing) and in addition can be utilized as a terminal to download documents from a network.

Additional aspects or components of the device 900 are conventional (unless otherwise discussed herein), and in the interest of clarity and brevity are not discussed in detail herein. Such aspects and components are discussed, for example, in “How Computers Work”, by Ron White (Que Corporation 1999), and “How Networks Work”, by Frank J. Derfler, Jr. and Les Freed (Que Corporation 2000), the entire contents of each of which are incorporated herein by reference.

Further, it should be appreciated that the user terminal referenced herein, such as terminal 29, can be constituted by a computer (such as shown in FIG. 8), a multi-function device (such as shown in FIG. 9), or another network-capable device that is configured to connect to a network and communicate over the network with another network-connected device and that is configured with sufficient resources to receive the application provided by an application supplying apparatus and to provide a user interface.

Referring back to FIG. 2, according to another aspect of this embodiment, if the user instruction received via the common user interface part 20b corresponds to a scan operation instruction, the application processing unit 20c converts the scan operation instruction into a format native to the selected device (e.g., MFD A, MFD B, or another device in the system having the required scan functionalities), transmits the converted scan operation instruction to the selected device to cause the selected device to perform the scan operation, and receives scan image data from the device in the format native to the device.

On the other hand, some functionalities of a particular device may require specifying another device, such as to store resulting scan image data, or otherwise output the data to, such other device. Thus, the user interface configured specific to the selected device can allow the user to specify one of the other devices in the system to be a destination for storing the scan image data, based on the user instruction. For example, if the user instruction is a scan operation instruction to scan data, the user instruction will typically include a user specification of a storage location on one of the plural server devices for storing the resulting scan image data. For example, the common user interface part may display the user interface screen of FIG. 6 to allow the user to select a storage location and/or storage file for storing the resulting scan image data. The application processing unit 20c will determine which device (e.g., server A, server B, etc.) is to store the user-designated file. Thus, after the application processing unit 20c receives scan image data from the selected device, which still has to be transmitted to one of the devices for storage, the application processing unit 20c determines a device from amongst the plural devices in the system based on the user instruction, and converts (i) the scan image data (which is in the format native to the selected device) and (ii) the user instruction, into a format native to the specific device that will store the converted data. Thereafter, the application processing unit 20c transmits the converted scan image data and converted user instruction to the specific device in the format native to the specific device, based on the user instruction (i.e. to store the scan image data at the user designated location).

According to the aforementioned aspects, if the scan operation instruction (i.e. user instruction received via the user interface provided by the common user interface part 20b) includes an instruction to store the scan image data in a particular storage unit connected to the specific server device, the application processing unit 20c transmits the converted scan image data and scan operation instruction to the particular device in the format native to the particular device, to cause the particular device store the scan image data in the particular storage unit. On the other hand, if the scan operation instruction (i.e. user instruction received via common user interface part 20b) includes an instruction to email the scan image data to a particular email address, the application processing unit 20c transmits the converted scan image data and scan operation instruction to the specific email device in the format native to the specific email device, to cause the specific email device to email the scan image data to the particular email address. The specific email device may correspond to, for example, an email server such as a Simple Mail Transfer Protocol (SMTP) server.

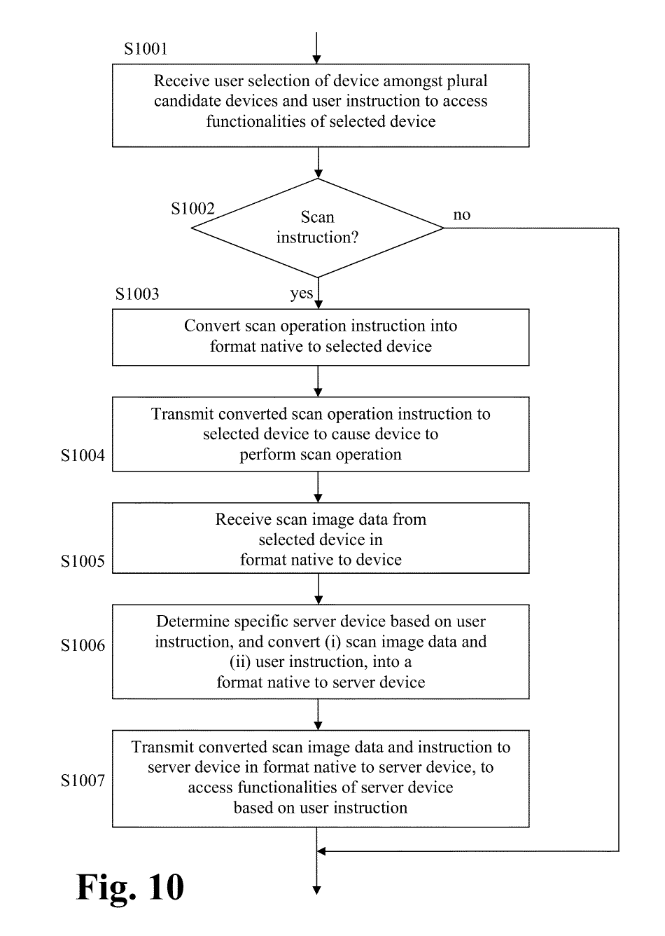

In FIG. 10, there is shown a flowchart of a method performed by an application supplying apparatus, such as application supplying apparatus 20 illustrated in FIG. 2, according to an exemplary embodiment.

In S1001, the common user interface part 20b of the application supplying apparatus 20 receives a user selection of a specific one of the plural multi-function devices (e.g., MFD A or MFD B) and receives a user instruction to access functionalities of the selected multi-function device. In S1002, the application processing unit 20c determines whether the user instruction corresponds to a scan operation instruction, and if the user instruction corresponds to a scan operation instruction (S1002, yes), converts the scan operation instruction into the format native to the selected multi-function device (in S1003). In S1004, the application processing unit 20c transmits the converted scan operation instruction to the selected multi-function device to cause the selected multi-function device to perform the scan operation, and in S1005 receives scan image data from the selected multi-function device in the format native to the selected multi-function device.

In S1006, the application processing unit 20c determines a specific server device from among plural server devices (e.g., server A or server B) for receiving the scan image data, based on the user instruction, and converts (i) the scan image data received through the application processing unit 20c in the format native to the selected multi-function device and (ii) the user instruction, into a format native to the specific server device. In S1007, the application processing unit 20c transmits the converted scan image data and the converted user instruction to the specific server device in the format native to the specific server device, to access the functionalities of the specific server device (i.e. store the scan image data at a storage location connected to the specific server device) based on the user instruction.

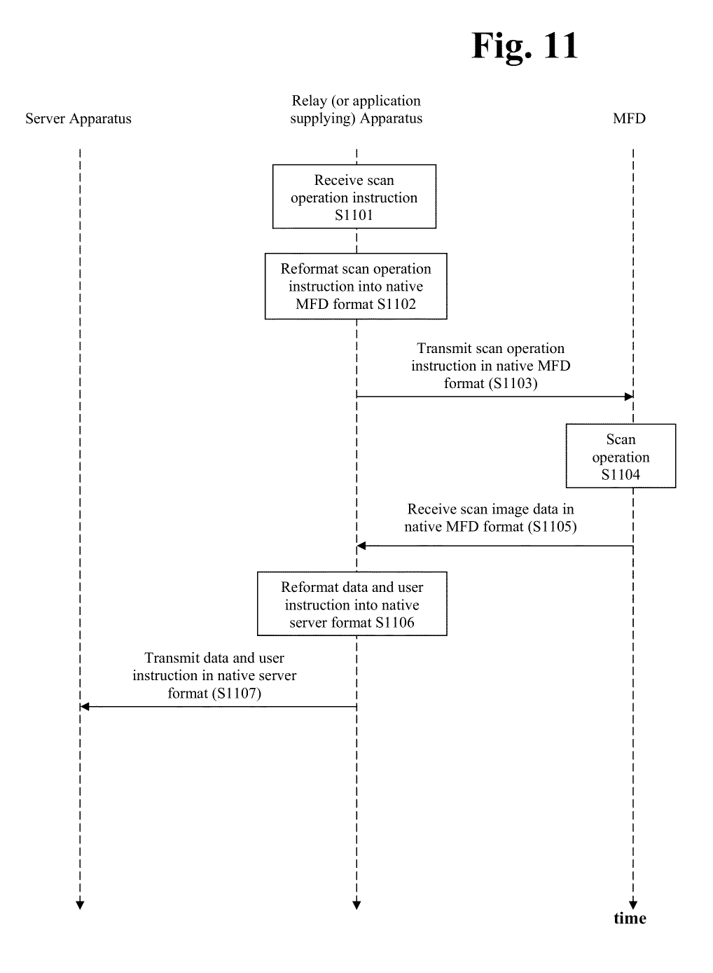

In FIG. 11, there is shown a schematic diagram of a data flow in a system, such as system 200 illustrated in FIG. 2, according to an exemplary embodiment.

In S1101, the application supplying apparatus 20 receives a user selection of a specific one of the plural multi-function devices (e.g., MFD A or MFD B), and a user instruction corresponding to a scan operation instruction. In S1102, the application supplying apparatus converts/reformats the scan operation instruction into the format native to the selected multi-function device. In S1103, the application supplying apparatus 20 transmits the converted scan operation instruction to the selected multi-function device to cause the selected multi-function device to perform the scan operation, and in S1104 the selected multi-function device performs the scan operation. In S1105, the application supplying apparatus receives scan image data from the selected multi-function device in the format native to the selected multi-function device, and in S1106, the application supplying apparatus 20 converts (i) the scan image data in the format native to the selected multi-function device and (ii) the user instruction, into a format native to the specific server device. In S1107, the application supplying apparatus 20 transmits the converted scan image data and the converted user instruction to the specific server device in the format native to the specific server device, to access the functionalities of the specific server device (i.e. store the scan image data at a storage location connected to the specific server device) based on the user instruction.

Referring back to FIG. 2, according to another aspect of this embodiment, if the user instruction received via the common user interface part 20b corresponds to a print operation instruction, the application processing unit 20c converts the print operation instruction into the format native to the selected multi-function device (e.g., MFD A or MFD B), the application processing unit 20c transmits the converted print operation instruction to the selected multi-function device to cause the selected multi-function device to process the print operation instruction, and receives a data request from the selected multi-function device in the format native to the selected multi-function device.

The application processing unit 20c then determines a specific one of the server devices (e.g., server A or server B) that stores the document or file that the user wishes to print. For example, if the user instruction is a print operation instruction to print data, the user instruction will typically include a user specification of a file or document stored at a storage location connected to one of the plural server devices for printing. The application processing unit 20c will determine which server device (e.g., server A or server B) corresponds to the user designated storage location and/or storage file. Thus, after the application processing unit 20c receives a data request for print data from the selected MFD, the application processing unit determines a specific server device from among the plural server devices based on the user instruction, and converts (i) the data request received through the device connector part (which is in the format native to the selected multi-function device) and (ii) the user instruction, into a format native to the specific server device. Thereafter, the application processing unit 20c transmits the converted data request and converted user instruction to the specific server device in the format native to the specific server device, to access the functionalities of the specific server device based on the user instruction (i.e. to request the user-specified file stored at the storage location connected to the particular server device).

After the specific server device responds with the requested file or document data, the application processing unit 20c converts the document data into print data in the format native to the selected multi-function device, e.g., Printer Description Language (PDL), Printer Control Language (PCL), PostScript, etc. The application processing unit 20c transmits the print data to the selected multi-function device to cause the selected multi-function device to perform the print operation.

The application processing unit 20c may convert the document data into any standard printable format printable by the selected multi-function device e.g., Printer Description Language (PDL), Printer Control Language (PCL), PostScript, etc. This may be particularly useful in the case where the selected multi-function device is newly discovered or recently connected to the application processing unit 20c, and thus a particular format native to the selected multi-function device may not yet have been ascertained.

Since the application supplying apparatus converts document data into print data printable by the selected multi-function device, the application supplying apparatus functions as a ‘black box’ printer driver, eliminating the need for any printer drivers to be installed on any of the server devices, on any of the multi-function devices, or on any user terminals connected to the application supplying apparatus that may request a print job, and so forth.

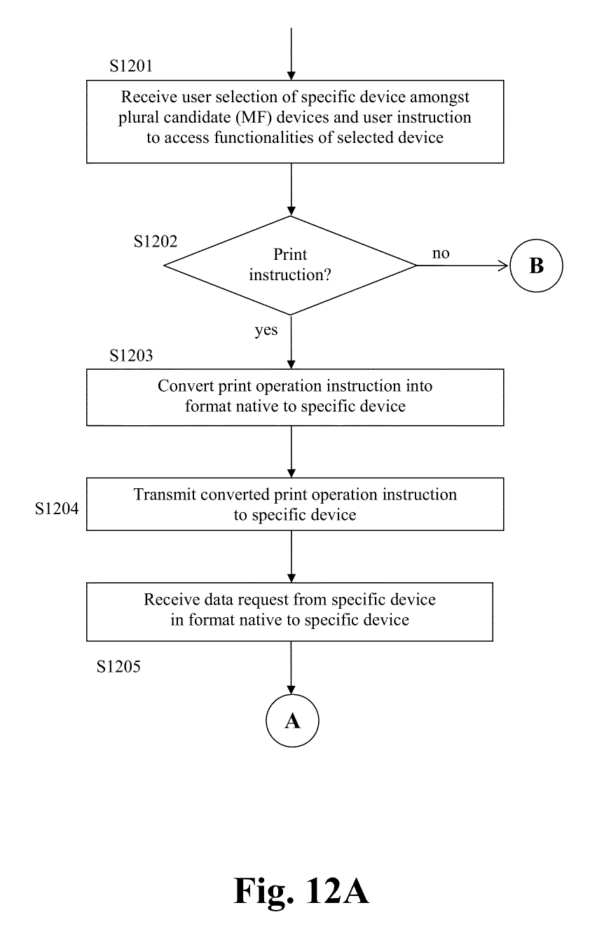

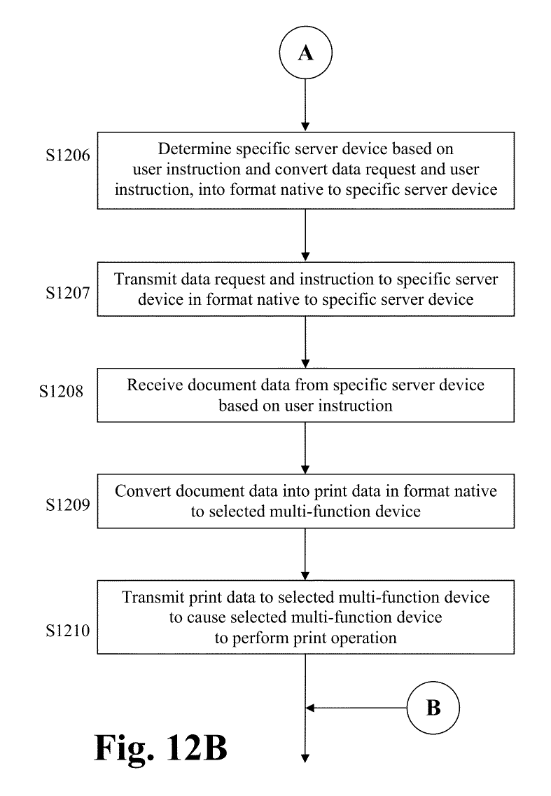

In FIGS. 12A and 12B, there is shown a flowchart of a method performed by an application supplying apparatus, such as application supplying apparatus 20 illustrated in FIG. 2, according to an exemplary embodiment.

In S1201, user selection of a specific one of the plural multi-function devices (e.g., MFD A or MFD B) and a user instruction to access functionalities of the selected device are received through the common user interface part 20b of the application supplying apparatus 20. The application processing unit 20c determines whether the user instruction corresponds to a print operation instruction (S1202), and if the user instruction corresponds to a print operation instruction (S1202, yes), converts the print operation instruction into the format native to the selected multi-function device (in S1203). In S1204, the application processing unit 20c transmits the converted print operation instruction to the selected multi-function device, and in S1205 receives data request from the selected multi-function device in the format native to the selected multi-function device.

In S1206, the application processing unit 20c determines a specific server device from among plural server devices (e.g., server A or server B) for receiving the data request, based on the user instruction, and converts (i) the data request received through the application processing unit 20c in the format native to the selected multi-function device and (ii) the user instruction, into a format native to the specific server device. In S1207, the application processing unit 20c transmits the converted data request and the converted user instruction to the specific server device in the format native to the specific server device, to access the functionalities of the specific server device (i.e. to request the document data from a storage location connected to the specific server device) based on the user instruction.

In S1208, the application processing unit 20c receives document data from the specific server device based on the user instruction, and in S1209 the application processing unit 20c converts the document data into print data in the format native to the selected multi-function device. Finally, in S1209, the application processing unit 20c transmits the print data to the selected multi-function device to cause the selected multi-function device to perform the print operation and print the print data.

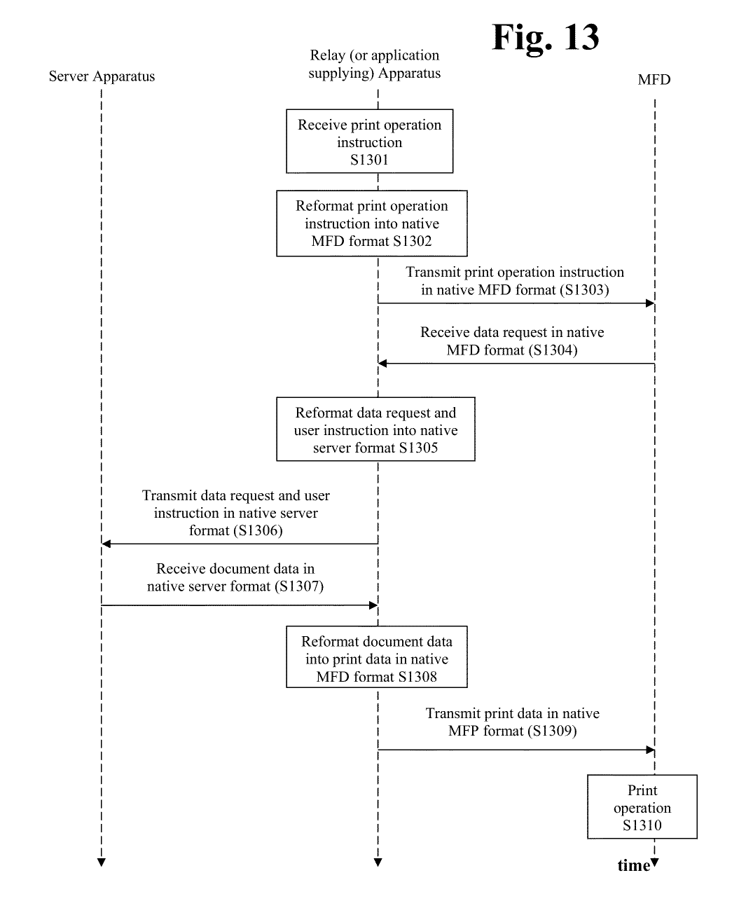

In FIG. 13, there is shown a schematic diagram of a data flow in a system, such as system 200 illustrated in FIG. 2, according to an exemplary embodiment.

In S1301, the application supplying apparatus 20 receives a user selection of a specific one of the plural multi-function devices (e.g., MFD A or MFD B), and a user instruction corresponding to a print operation instruction. In S1302, the application supplying apparatus converts/reformats the print operation instruction into the format native to the selected multi-function device. In S1303, the application supplying apparatus 20 transmits the converted print operation instruction to the selected multi-function device, and in S1304 the application supplying apparatus receives a data request from the selected multi-function device in the format native to the selected multi-function device. In S1305, the application supplying apparatus 20 converts (i) the data request in the format native to the selected multi-function device and (ii) the user instruction, into a format native to the specific server device. In S1306, the application supplying apparatus 20 transmits the converted data request and the converted user instruction to the specific server device in the format native to the specific server device, to access the functionalities of the specific server device (i.e. to request the document data from a storage location connected to the specific server device) based on the user instruction.

In S1307, the application supplying apparatus receives document data from the specific server device based on the user instruction, and in S1308 the application supplying apparatus converts the document data into print data in the format native to the selected multi-function device. Finally, in S1308, the application supplying apparatus transmits the print data to the selected multi-function device to cause the selected multi-function device to perform the print operation in S1310 and print the print data.

Referring back to FIG. 2, according to another aspect of this embodiment, if the user instruction received via the common user interface part 20b corresponds to a print operation instruction, the application processing unit 20c then determines a specific one of the server devices (e.g., server A or server B) that stores the document or file that the user wishes to print. For example, if the user instruction is a print operation instruction to print data, the user instruction will typically include a user specification of a file or document stored at a storage location connected to one of the plural server devices for printing. The application processing unit 20c will determine which server device (e.g., server A or server B) corresponds to the user designated storage location and/or storage file.

The application processing unit 20c then generates a print data request in the format native to the specific server device, based on the print operation instruction, the application processing unit 20c transmits the print data request to the specific server device, and the application processing unit 20c receives document data from the specific server device. The application processing unit 20c then converts the document data into print data in the format native to the selected multi-function device, e.g., Printer Description Language (PDL), Printer Control Language (PCL) or PostScript, and converts the print operation instruction into the format native to the selected multi-function device. Finally, the application processing unit 20c transmits the converted print data and print operation instruction to the selected multi-function device, to cause the selected multi-function device to perform the print operation.

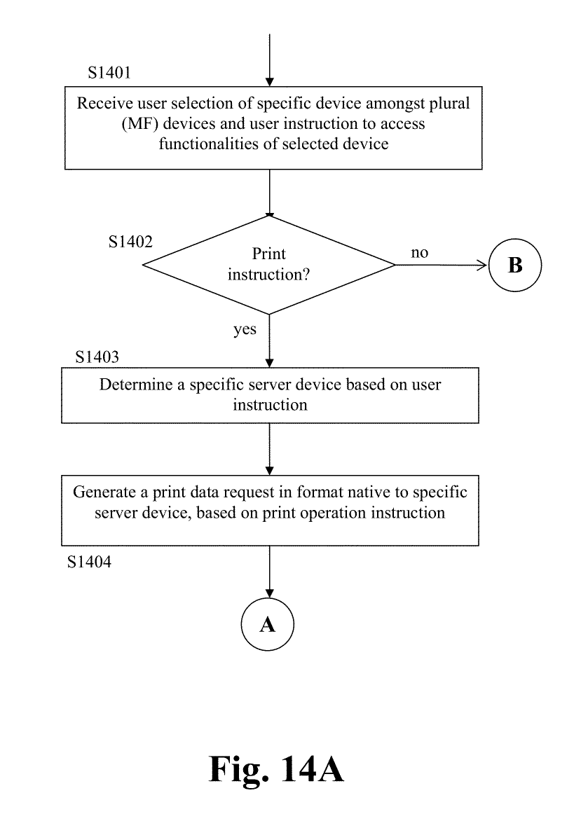

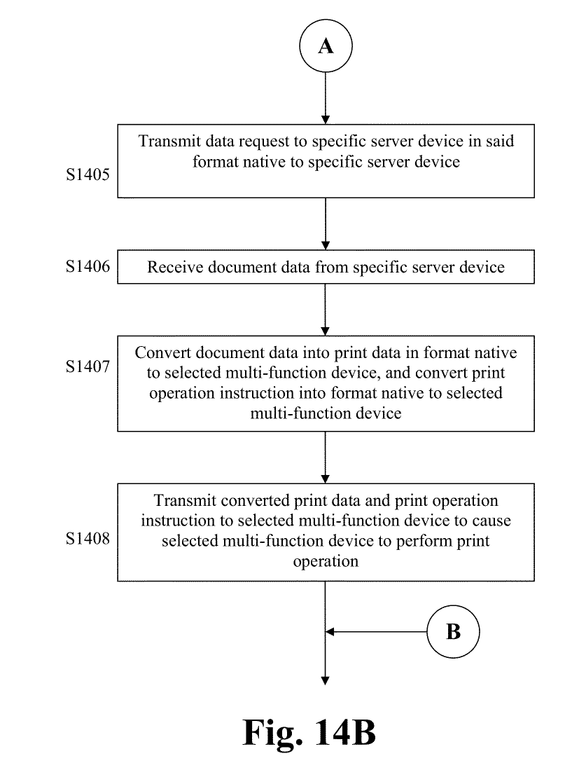

In FIGS. 14A and 14B, there is shown a flowchart of a method performed by an application supplying apparatus, such as application supplying apparatus 20 illustrated in FIG. 2, according to an exemplary embodiment.

In S1401, the common user interface part 20b of the application supplying apparatus 20 receives a user selection of a specific one of the plural multi-function devices (e.g., MFD A or MFD B) and a user instruction to access functionalities of the selected multi-function device. Then, the application processing unit 20c determines whether the user instruction corresponds to a print operation instruction (S1402), and if the user instruction corresponds to a print operation instruction (S1402, yes), determines based on the user instruction a specific server device from among plural server devices (e.g., server A or server B) for receiving a data request, (S1403), and generates a print data request in the format native to the specific server device, based on the print operation instruction (S1404). In S1405, the application processing unit 20c transmits the print data request to the specific server device, and in S1406 receives document data from the specific server device. In S1407, the application processing unit 20c converts the document data into print data in the format native to the selected multi-function device, and converts the print operation instruction into the format native to the selected multi-function device. Finally, in S1408, the application processing unit 20c transmits the converted print data and print operation instruction to the selected multi-function device, to cause the selected multi-function device to perform the print operation.

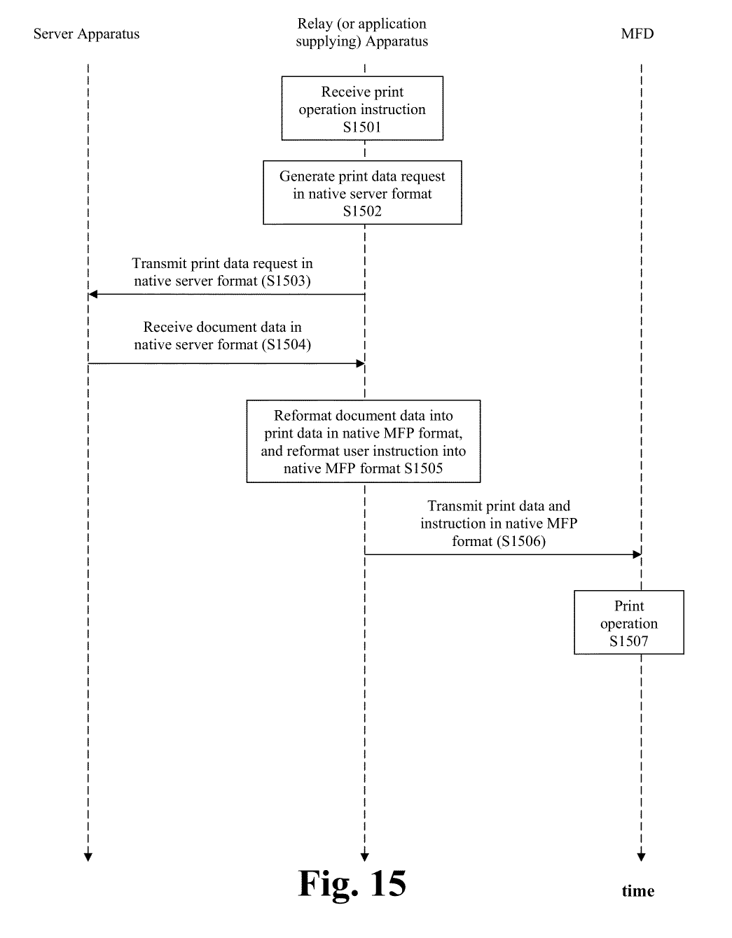

In FIG. 15, there is shown a schematic diagram of a data flow in a system, such as system 200 illustrated in FIG. 2, according to an exemplary embodiment.

In S1501, the application supplying apparatus 20 receives a user selection of a specific one of the plural multi-function devices (e.g., MFD A or MFD B), and a user instruction corresponding to a print operation instruction. In S1502, the application supplying apparatus generates a print data request in the format native to the specific server device, based on the print operation instruction. In S1503, the application supplying apparatus transmits the print data request to the specific server device, and in S1504 receives document data from the specific server device. In S1505, the application supplying apparatus converts the document data into print data in the format native to the selected multi-function device, and converts the print operation instruction into the format native to the selected multi-function device. Finally, in S1506, the application supplying apparatus transmits the converted print data and print operation instruction to the selected multi-function device, to cause the selected multi-function device to perform the print operation in S1507.

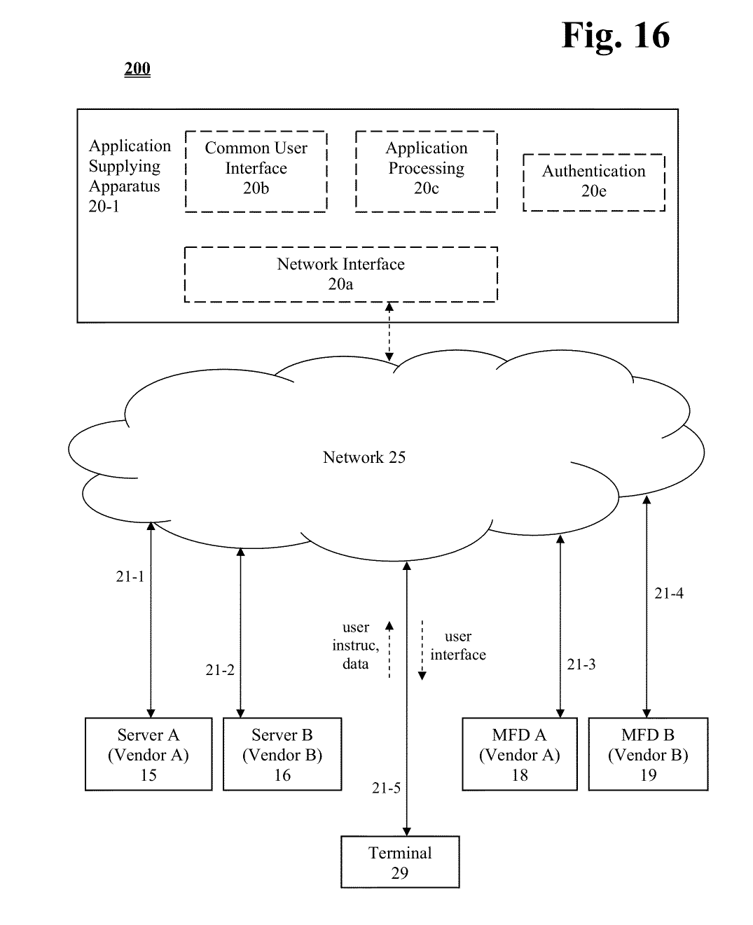

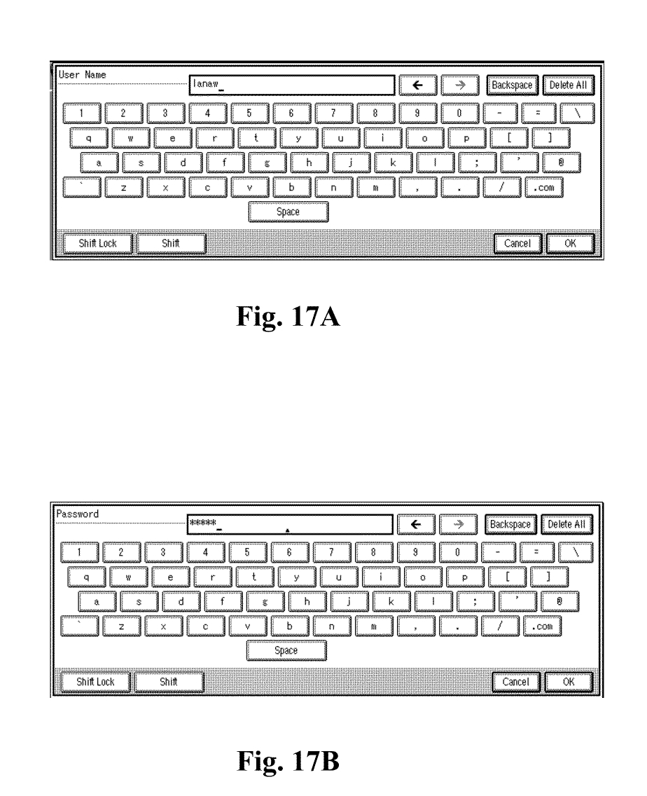

Turning now to FIG. 16, there is described another embodiment of this disclosure. In FIG. 16 there is illustrated a system 1600 similar to the system 200 illustrated in FIG. 2, with application supplying apparatus 20-1 of FIG. 16 being similar to application supplying apparatus 20 of FIG. 2, except that application supplying apparatus 20-1 further includes an authentication part 20e. The authentication part 20e is configured to authenticate the user of the application supplying apparatus. For example, the authentication part may display a user interface screen on a display part of the application supplying apparatus to permit the user to enter a username and password to be authenticated. FIG. 17A illustrates an example of a user interface screen that may be displayed on the application supplying apparatus in order to permit a user to enter their username. FIG. 17B illustrates an example of a user interface screen that may be displayed on the application supplying apparatus in order to permit a user to enter their password. The user's username and password may be authenticated against an authentication server (e.g., using Lightweight Directory Access Protocol or Active Directory, etc.). Instead, or in addition, the user's username and password may be authenticated against a local address book stored at the application supplying apparatus.

Other methods of authentication may also be used. For example, the application supplying apparatus 20-1 may be equipped with one or more biometrics means (such as comparing fingerprints, palm prints, voice or speech, retinas or irises, facial expressions or features, signature, etc.). As another example, the application supplying apparatus 20-1 may be equipped with a card reader to read an Identification Card or IC card of the user, in order to authenticate the user by checking the identification information, profile information, username, password, etc. stored on the IC card.

According to this exemplary embodiment, the user must be authenticated with respect to a specific multi-function device (e.g., MFD A or MFD B), in order for the application supplying apparatus to permit the user instruction to be transmitted to the specific multi-function device in accordance with the various aspects described throughout this disclosure. For example, the user authentication part may store an access control list (ACL) indicating which users are permitted to use each of the different multi-function devices (e.g., MFD A or MFD B). The application processing unit 20c only converts the user instruction into the format native to the selected multi-function device, and/or the application processing unit 20c only transmits information to the selected multi-function device, if the user authentication part 20e determines that the user is authenticated to access the functionalities of the selected multi-function device.

According to this exemplary embodiment, the user must also be authenticated with respect to a specific server device (e.g., server A or server B), in order for the application supplying apparatus to access the functionalities of the specific server device in accordance with the various aspects described throughout this disclosure. For example, the user authentication part may store an access control list (ACL) indicating which users are permitted to use each of the different server device (e.g., server A or server B). The application processing unit 20c only converts the data into the format native to the selected server device, and/or the application processing unit 20c only transmits information to the specific server device, if the user authentication part determines that the user is authenticated to access the specific server device.

Moreover, by authenticating the user of the application supplying apparatus, the authentication part 20e also permits various information to be collected with respect to the logged in user. For example, cost or accounting data can be collected and accumulated for the logged in user, based on the various scan or print jobs that may be performed by the logged in user. Such information can automatically be provided to accounting, billing or reimbursement departments, for example.

The aforementioned specific embodiments are illustrative, and many variations can be introduced on these embodiments without departing from the spirit of the disclosure or from the scope of the appended claims. For example, elements and/or features of different examples and illustrative embodiments may be combined with each other and/or substituted for each other within the scope of this disclosure and appended claims.

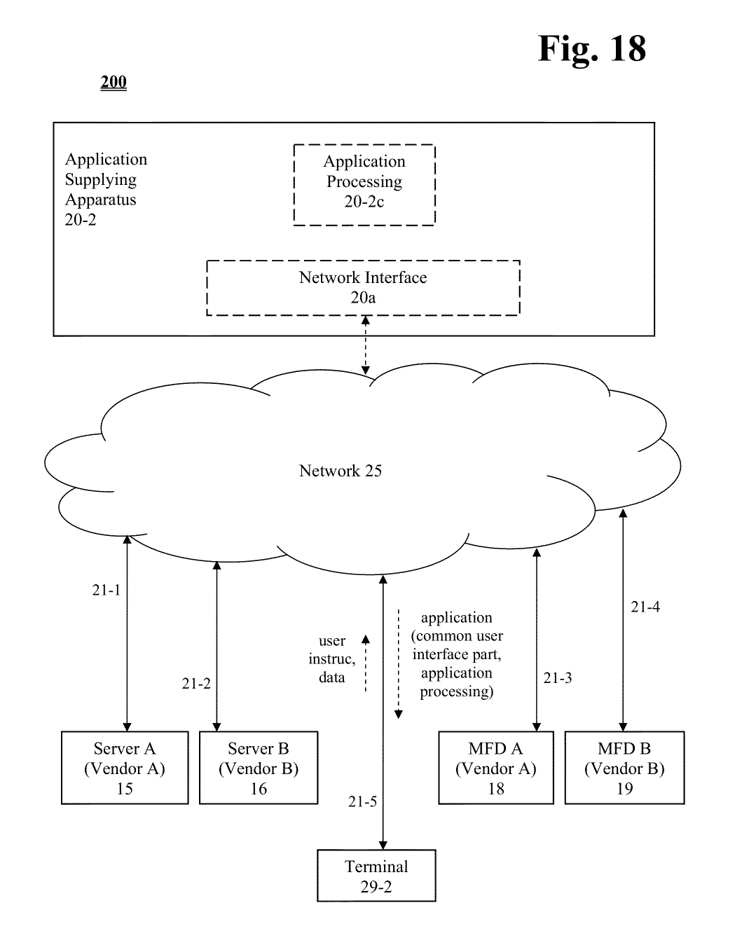

For example, the description above has been directed to an application supplying apparatus that operates similar to a cloud relay apparatus. In another exemplary embodiment (FIG. 18), application supplying apparatus 20-2 (more specifically, applications processing unit 20-2c) supplies the application in a manner known commonly as Software as a Service (SaaS) to user terminal 29-2, and the application executing on the user terminal 29-2 may include one or more other parts (in addition to the common user interface part). When the common user interface part receives user selection of a specific device (from amongst the plural heterogeneous devices) and receives user instruction to access functionalities of the selected device, an application processing part of the application executing on the user terminal can convert the user instruction received through the common user interface part into a format native to the selected device, and the application executing on the user terminal causes the terminal to transmit the converted instruction to the selected device in the format native to the selected device. Likewise, for some devices amongst the heterogeneous devices, some functionalities may involve input by the device of image data in a format native to the specific device. Thus, when the user invokes such functionalities of the specific device via the common user interface, the application processing unit may need to convert source image data (retrieved locally or from an external source) to converted data in the format native to the specific device.

What is claimed is:

1. An application supplying apparatus comprising a network interface unit for communication through a network, a processing unit and a storage unit storing an application service program embodying a program of instructions executable by the processing unit to supply an application through the network interface unit via the network to a user terminal having a network communication unit, for user access to functionalities of plural heterogeneous devices connected to the network,
wherein said application supplied by said application supplying apparatus via the network to the user terminal includes a common user interface part that provides a user interface on the user terminal, receives user selection through the user interface of a specific device from the plural devices and configures the user interface to be specific to the selected device, to receive user instruction for access to functionalities of the selected device,
wherein the user instruction received through the user interface is communicated through the network communication unit of the user terminal via the network to the application supplying apparatus, and
wherein said application supplying apparatus further includes an application processing unit that converts the user instruction received from the user terminal to a format native to the selected device, and causes the converted instruction in said format native to the selected device to be communicated through the network interface unit to the selected device, to access said functionalities of the selected device.

2. The application supplying apparatus of claim 1, wherein the application processing unit of the application supplying apparatus, in a case that the user instruction received from the user terminal corresponds to an instruction to perform a scan operation instruction and to store the scan image data in a particular storage device, converts the scan operation instruction into the format native to the selected device and causes the converted scan operation instruction to be transmitted to the selected device to cause the selected device to perform the scan operation, and causes scan image data generated by the selected device in a specific format native to the selected device to be converted into a different format native to the particular storage device, and causes the converted scan image data to be transmitted to the particular storage device in said format native to the particular storage device.

3. The application supplying apparatus of claim 1, wherein the application processing unit of the application supplying apparatus, in a case that the user instruction corresponds to an instruction to perform a scan operation instruction and to email the scan image data to a particular email address, converts the scan operation instruction into the format native to the selected device and causes the converted scan operation instruction to be transmitted to the selected device to cause the selected device to perform the scan operation, and causes scan image data generated by the selected device in a specific format native to the selected device to be converted into a different format, and causes the converted scan image data to be emailed to the particular email address.

4. The application supplying apparatus of claim 1, wherein the application processing unit of the application supplying apparatus, in a case that the user instruction corresponds to a print operation instruction, causes document data to be retrieved and then converted into print data in the format native to the selected device, converts the print operation instruction into the format native to the selected device, and transmits the converted print data and print operation instruction to the selected device, to cause the selected device to perform the print operation.

5. The application supplying apparatus of claim 1, further comprising an authentication unit configured to authenticate the user of the user terminal, and the application processing unit only converts the user instruction into the format native to the selected device, in a case that the user authentication part determines that the user is authenticated to access the functionalities of the selected device.

6. An application supplying apparatus comprising a network interface unit for communication through a network, a processing unit and a storage unit storing an application service program embodying a program of instructions executable by the processing unit to supply an application through the network interface unit via the network to a user terminal for user access to functionalities of plural heterogeneous devices, wherein said application supplied by said application supplying apparatus via the network to the user terminal comprises:
a common user interface part that provides a user interface on the user terminal, receives user selection through the user interface of a specific device from the plural devices and configures the user interface to be specific to the selected device, for access to functionalities of the selected device; and
an application processing unit configured to cause the user terminal to communicate with the selected device to transmit user instruction, received through the user interface, in a format native to the selected device to, and receive data from, the selected device in said format native to the selected device, to access said functionalities of the selected device.

7. The application supplying apparatus of claim 6, wherein the application processing unit of the application supplied by said application supplying apparatus via the network to the user terminal, in a case that the user instruction corresponds to a print operation instruction, converts the print operation instruction into the format native to the selected device and transmits the converted print operation instruction to the selected device to cause the selected device to process the print operation instruction, and in response to a data request from the selected device in the format native to the selected device, causes document data to be converted into print data in the format native to the selected device, and causes the print data to be transmitted to the selected device to cause the selected device to perform the print operation.

8. The application supplying apparatus of claim 6, wherein the application processing unit of the application supplied by said application supplying apparatus via the network to the user terminal, in a case that the user instruction corresponds to a print operation instruction, causes document data to be retrieved and then converted into print data in the format native to the selected device, converts the print operation instruction into the format native to the selected device, and transmits the converted print data and print operation instruction to the selected device, to cause the selected device to perform the print operation.

9. The application supplying apparatus of claim 6, wherein the application processing unit of the application supplied by said application supplying apparatus via the network to the user terminal, in a case that the user instruction corresponds to an instruction to perform a scan operation instruction and to store the scan image data in a particular storage device, converts the scan operation instruction into the format native to the selected device and causes the converted scan operation instruction to be transmitted to the selected device to cause the selected device to perform the scan operation, and causes scan image data generated by the selected device in a specific format native to the selected device to be converted into a different format native to the particular storage device, and causes the converted scan image data to be transmitted to the particular storage device in said format native to the particular storage device.

10. The application supplying apparatus of claim 6, wherein the application processing unit of the application supplied by said application supplying apparatus via the network to the user terminal, in a case that the user instruction corresponds to an instruction to perform a scan operation instruction and to email the scan image data to a particular email address, converts the scan operation instruction into the format native to the selected device and causes the converted scan operation instruction to be transmitted to the selected device to cause the selected device to perform the scan operation, and causes scan image data generated by the selected device in a specific format native to the selected device to be converted into a different format, and causes the converted scan image data to be emailed to the particular email address.

11. The application supplying apparatus of claim 6, wherein the application supplied by said application supplying apparatus via the network to the user terminal further comprises an authentication part configured to authenticate the user of the user terminal, and the application processing unit only converts the user instruction into the format native to the selected device, in a case that the user authentication part determines that the user is authenticated to access the functionalities of the selected device.

12. A method for access from a user terminal to functionalities of plural heterogeneous devices, said method comprising:
(a) providing by an application supplying apparatus through a network to the user terminal an application including a common user interface part;
(b) receiving, through a user interface provided by the common user interface part of the application to the user terminal, user selection of a specific one of the plural devices;
(c) causing the user interface to be configured to be specific to the selected device, for access to functionalities of the selected device, in response to user selection of the specific device;
(d) receiving user instruction through the user interface configured for access to the functionalities of the selected device; and
(e) causing the user instruction to be converted to a format native to the selected device, and causing the converted instruction in the format native to the selected device to be communicated to the selected device, to access said functionalities of the selected device.

13. The method of claim 12, further comprising:
authenticating the user for access to the functionalities of the selected device,
wherein (c), (d) and (e) are performed only if the user is authenticated for access to the functionalities of the selected device.

14. The method of claim 12, further comprising:
determining that the user instruction entered through the user interface corresponds to an instruction to perform a scan operation instruction and to store the scan image data in a particular storage device;
causing the scan operation instruction to be converted to the format native to the selected device, and causing the converted scan operation instruction in the format native to the selected device to be transmitted to the selected device to cause the selected device to perform the scan operation;
causing scan image data generated by the selected device in a specific format native to the selected device to be converted into a different format native to the particular storage device; and
causing the converted scan image data to be transmitted to the particular storage device in said format native to the particular storage device.

15. The method of claim 12, further comprising:
determining that the user instruction corresponds to an instruction to perform a scan operation instruction and to email the scan image data to a particular email address;
causing the scan operation instruction to be converted to the format native to the selected device, and causing the converted scan operation instruction in the format native to the selected device to be transmitted to the selected device to cause the selected device to perform the scan operation;
causing scan image data generated by the selected device in a specific format native to the selected device to be converted into a different format; and
causing the converted scan image data to be emailed to the particular email address.

16. The method of claim 12, further comprising:
determining that the user instruction corresponds to a print operation instruction;
causing the print operation instruction to be converted to the format native to the selected device, and causing the converted print operation instruction in the format native to the selected device to be transmitted to the selected device to cause the selected device to perform the print operation;
causing document data to be converted into print data in the format native to the selected device; and
causing the print data to be transmitted to the selected device to cause the selected device to perform the print operation.

17. The method of claim 12, further comprising:
determining that the user instruction corresponds to a print operation instruction;
causing document data to be retrieved and then converted into print data in the format native to the selected device;
causing the print operation instruction to be converted to the format native to the selected device; and
transmitting the converted print data and the converted print operation instruction in the format native to the selected device to the selected device, to cause the selected device to perform the print operation.

18. A system comprising:
a user terminal including a network communication unit to communicate through a network; and
application supplying apparatus comprising a network interface unit for communication through the network, a processing unit and a storage unit storing an application service program embodying a program of instructions executable by the processing unit to supply an application through the network interface unit via the network to the user terminal for user access to functionalities of plural heterogeneous devices connected to the network,
wherein said application supplied by said application supplying apparatus via the network to the user terminal includes a common user interface part that provides a user interface on the user terminal, receives user selection through the user interface of a specific device from the plural devices and configures the user interface to be specific to the selected device, to receive user instruction for access to functionalities of the selected device,
wherein the user instruction received through the user interface is communicated through the network communication unit of the user terminal to the application supplying apparatus, and
wherein said application supplying apparatus further includes an application processing unit that converts the user instruction received from the user terminal to a format native to the selected device, and causes the converted instruction in said format native to the selected device to be communicated through the network interface unit to the selected device, to access said functionalities of the selected device.
